(19) United States
(12) Patent Application Publication
(10) Pub. No.: US 2023/0131764 A1
(43) Pub. Date: Apr. 27, 2023

(54) PROPERTIES OF OBJECTS BASED ON TRANSMISSION CALCULATIONS

(71) Applicant: Hewlett-Packard Development Company, L.P., Spring, TX (US)

(72) Inventors: Melanie M. GOTTWALS, Palo Alto, CA (US); Ingeborg TASTL, Palo Alto, CA (US)

(73) Assignee: Hewlett-Packard Development Company, L.P., Spring, TX (US)

(21) Appl. No.: 17/917,970

(22) PCT Filed: Apr. 15, 2020
(86) PCT No.: PCT/US2020/028300

§ 371 Date: Oct. 10, 2022

(51) Int. Cl. G01N 21/59; B29C 64/393; B33Y 50/02; B33Y 10/00; B33Y 30/00

(52) U.S. Cl. CPC G01N 21/59; B29C 64/393; B33Y 50/02; B33Y 10/00; B33Y 30/00

(57) ABSTRACT

In example implementations, an apparatus is provided. The apparatus includes a light table, a camera, and a processor communicatively coupled to the light table and the camera. The light table is to emit light through an object on the light table. The camera is to capture an image of the light table. The processor is to receive an image of the light table without the object, receive an image of the light table with the object, and calculate a transmission value for each pixel of the object in the image of the light table with the object, wherein a mechanical property of the object is to be determined based on the transmission value of the object.

### BACKGROUND

Three-dimensional printers can be used to print three-dimensional (3D) objects. The 3D printers can use additive manufacturing methods such as selective laser sintering, fused deposition modeling, and the like. A model of the object can be created on a computer and transmitted to the 3D printer. The 3D printer may build the object based on the computer rendered image in a layer-by-layer process.

The properties of the 3D object can be examined after printing. The properties of the 3D object can provide information related to the quality of the 3D printer, proper printing parameters for the 3D printer, possible errors or malfunctions on the 3D printer, and the like. A device to measure the properties of the 3D object may actually break the 3D object to obtain certain information. In addition, the device can examine one 3D object at a time

### BRIEF DESCRIPTION OF THE DRAWINGS

FIG. 1 is a block diagram of an example apparatus to measure properties of an object based on transmission measurements of the present disclosure;

FIG. 2 is a block diagram of example captured images of the object on the light table of the apparatus and how transmission measurements are calculated in the present disclosure;

FIG. 3 is a block diagram of an example of pixels of the object in the image of the object on the light table of the present disclosure;

FIG. 4 is a block diagram of an example 3D printer and calibration of the 3D printer based on the transmission measurements of the present disclosure;

FIG. 5 is a flow diagram of an example method for measuring properties of an object based on transmission measurements; and

FIG. 6 illustrates an example non-transitory computer readable storage medium storing instructions executed by a processor to calibrate a 3D printer based on transmission measurements of the present disclosure.

### DETAILED DESCRIPTION

Examples described herein provide an apparatus and method to determine properties of objects based on transmission calculations. As discussed above, 3D printers can be used to print objects. The properties of the objects can be examined to determine the print quality of the 3D printer. For example, print parameter adjustments may be made based on analysis of the printed object.

Some systems can analyze objects in a serial fashion one-by-one. In addition, during the analysis an object may be damaged or broken to determine certain properties. Thus, analysis of the objects may take a long time if there are many objects to be analyzed. In addition, the objects cannot be analyzed further once they are broken.

The present disclosure provides an apparatus and method that can analyze many objects at a time and measure properties of the objects without breaking the objects. As a result, the objects can be further analyzed for additional properties.

In an embodiment, the present disclosure uses a light table and camera to capture images of the objects on the light table. Transmission values of the light through an object can be calculated. The transmission values can be compared to known transmission values associated with a particular property to determine the property for the object on the light table.

If the properties are unacceptable, print parameter adjustments can be determined to improve the properties of the object. The print parameter adjustments can be implemented in the 3D printer and the object can be printed. The process can be repeated to maintain a desired quality of the objects that are printed.

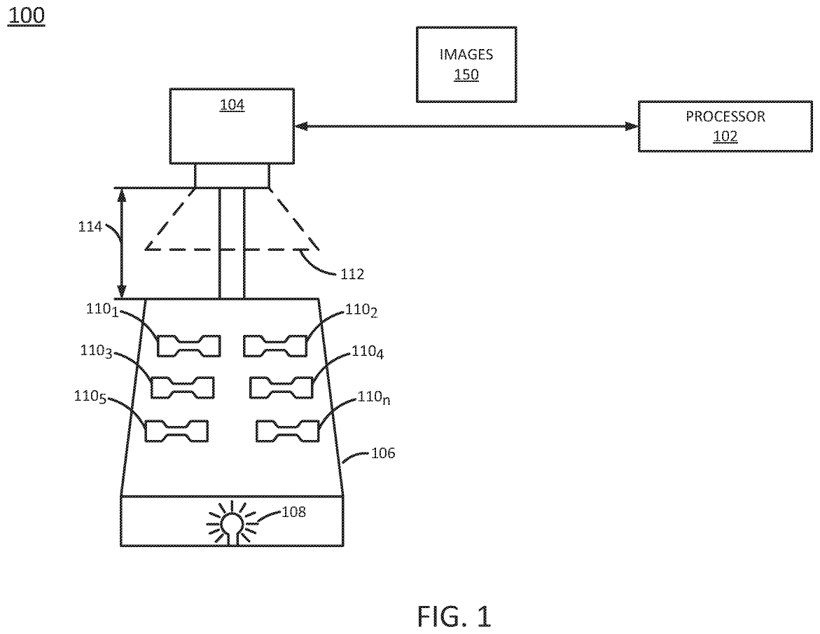

FIG. 1 illustrates an example apparatus 100 to measure properties of an object based on transmission measurements of the present disclosure. In an example, the apparatus 100 may include a processor 102, a camera 104, and a light table 106. The processor 102 may be communicatively coupled to the camera 104 to control operations of the camera 104.

In an example, the camera 104 may be any type of video or image capturing device. The camera 104 may be a red, green, and blue (RGB) camera, a monochromatic camera, and the like.

The light table 106 may include a light source 108 to emit light through a top surface of the light table 106 towards the camera 104. The light source 108 may be any type of light source, such as an incandescent light bulb, a light emitting diode, and the like.

In an example, the camera 104 may be positioned at a distance 114 away from a top surface of the light table 106. The distance 114 may be a vertical distance or height such that a field of view 112 of the camera 104 may capture the entire top surface of the light table 106 or a portion of the light table 106. The camera 104 may capture images 150 that can be transmitted to the processor 102. [owls] The images 150 may include an image of the light table 106 without any objects and an image of the light table 106 with objects 110₁ to 110ₙ (hereinafter also referred to individually as an object 110 or collectively as objects 110) on the light table 106. The objects 110 may be manufactured or printed via a three dimensional (3D) printer. The examples discussed herein are in reference to a 3D printer, however, it should be noted that the present disclosure may also apply to other types of manufacturing machines that produce objects 110.

In an example, the objects 110 may be produced in accordance with a particular testing standard. For example, some testing standards may suggest testing objects that are produced in a “dog bone” shape as illustrated in FIG. 1. However, it should be noted that any shaped objects 110 may be used on the light table 106.

In an example, the objects 110 may be translucent or partially translucent. In other words, the objects 110 may be printed with a material or at a thickness that allows some light emitted from the light table 106 to pass through the objects 110. Objects adhering to specific standards to determine mechanical properties may have a specific shape and size in x, y and z directions.

The images 150 of the light table 106 and the objects 110 can be analyzed by the processor 102 to determine mechanical properties of the objects 110. The mechanical properties may include properties such as ultimate tensile strength (UTS), elongation at break, printing consistency, and the like. These properties can be determined without damaging the objects 110. As a result, the objects 110 can be passed on to further analysis and testing of other parameters (e.g., visual defects, color consistency, and the like).

In addition, the images 150 of the light table 106 and the objects 110 may allow multiple objects 110 to be analyzed in parallel. Thus, many objects 110 can be analyzed simultaneously, creating a more efficient testing method and apparatus.

As noted above, the images 150 may be transmitted to the processor 102 for analysis to determine mechanical properties of an object 110 based on the images 150. The mechanical properties may be determined based on transmission measurements or values of the objects 110 calculated from the images 150. The mechanical properties can then be used to establish thresholds based on the correlation of mechanical properties to the transmission measurements. The thresholds can be used to evaluate the performance of the 3D printer or machine that produced the objects 110, and parameter adjustments may be made based on the determined mechanical properties of the objects 110.

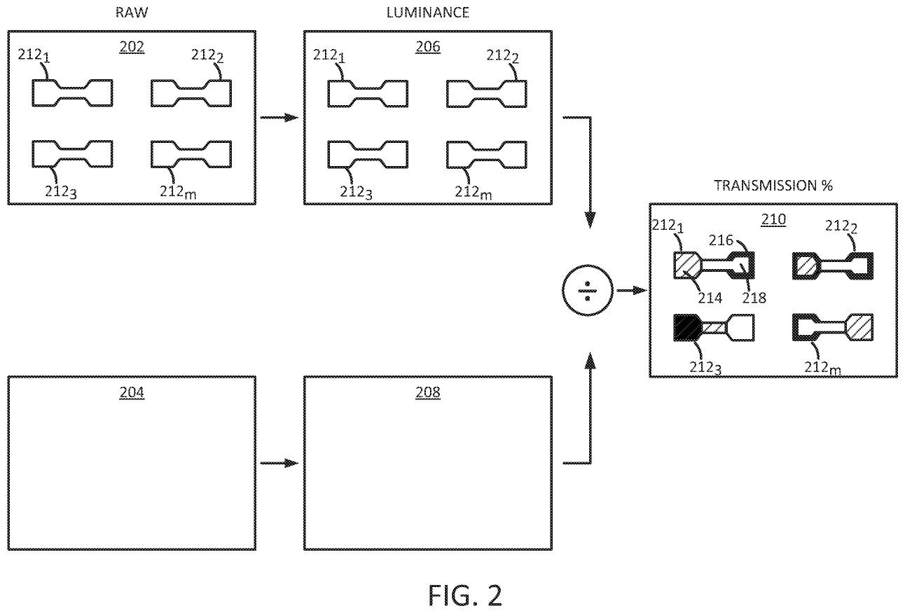

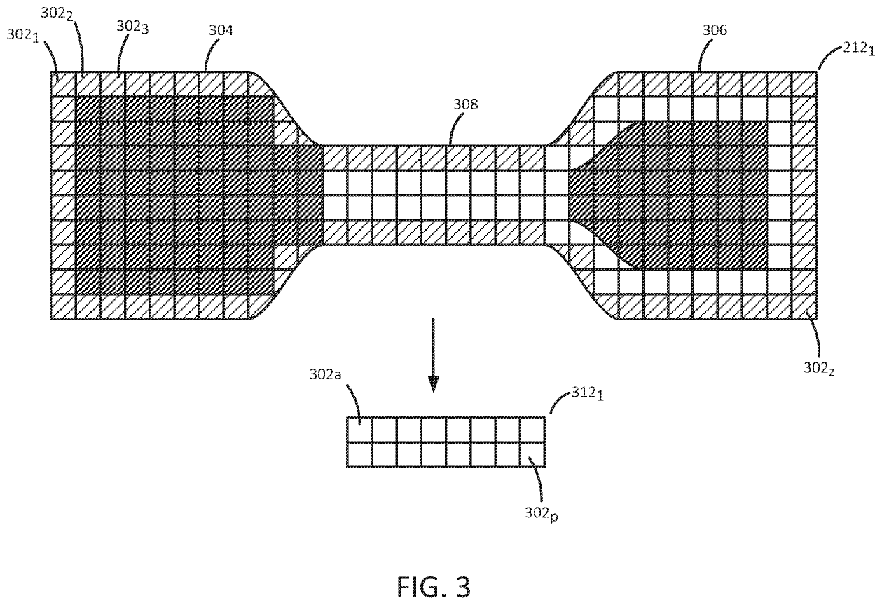

FIGS. 2 and 3 illustrate examples of how the transmission measurements of the objects 110 may be calculated. In an example, illustrated in FIG. 2, the images 150 may include a raw image 202 of the light table 106 with objects 212₁ to 212ₘ (hereinafter also referred to individually as an object 212 or collectively as objects 212) and a raw image 204 of the light table 106 without objects 212.

In an example, the raw images 202 and 204 may be converted into images 206 and 208 with luminance values. The luminance values may provide information related to a measure of brightness of the images 206 and 208. As will be discussed in further details with reference to FIG. 3 below, the luminance of each pixel of the images 206 and 208 may be assigned a value between 0 and 255 in an 8 bit image. The luminance may be based on weighted averages of RGB values for color images or grayscale values for black and white images.

In an example, the luminance values of pixels of the image 206 may be divided by the luminance values of corresponding pixels in the image 208 to calculate a transmission measurement for a pixel. The process may be repeated for each pixel of the images 206 and 208 to calculate a transmission percentage measurement for each pixel, which may be shown in an image 210.

In an example, the transmission measurements for each pixel within an object 212₁ to 212ₘ may be averaged to calculate an overall transmission measurement for each object 212₁ to 212ₘ. Each object 212₁ to 212ₘ may then be tested to calculate a desired mechanical property (e.g., UTS). The average transmission measurement may then be correlated to a mechanical property value or the desired mechanical property value. As discussed in further details below, a threshold may then be used to correlate to an acceptable level of the desired mechanical property value that can be used to determine the printing performance of a 3D printer or manufacturing performance of a machine.

However, as illustrated in FIG. 2, the transmission values can vary across an object 212 (e.g., as shown by different values in different areas 214, 216, and 218). In other words, the transmission values can be spatially non-uniform. Different portions of the objects 212 may have low transmission measurements that may not affect the mechanical property of the objects 212. Thus, taking an average transmission measurement of the entire object 212 may not provide an accurate correlation between the transmission percentage and the mechanical properties.

FIG. 3 illustrates how certain pixels can be excluded to provide a more accurate correlation between the transmission measurements and the mechanical property. FIG. 3 illustrates an example of the object 212₁ that includes pixels 302₁ to 302_{z} (also referred to herein individually as a pixel 302 or collectively as pixels 302). As can be seen in FIG. 3 based on various shading and hash marks, different pixels 302 may have different transmission measurements calculated, as described above with reference to FIG. 2. Variation in the transmission measurements may depend on where the pixels 302 are located in the object 212₁.

In an example, erosion techniques may be used to reduce or exclude some of the pixels 302 around a boundary of the image of the object 212₁. For example, in an example, the pixels 302 around the outer edge of the object 212₁ may be excluded when calculating the average transmission measurement for the object 212₁. In some examples, anywhere from 1 to 16 pixels from the boundary or outer edge may be excluded when calculating the average transmission measurement for the object 212₁.

In an example, segmentation techniques may be used to reduce or exclude some of the pixels 302. For example, outer portions 304 and 306 may have less of an effect on the mechanical property of the object 212₁ than a center portion 308 of the object 212₁. Thus, segmentation techniques may exclude pixels 302 in the outer portions 304 and 306. Said another way, the segmentation techniques may include a subset of the pixels 302 that are closer to the center portion 308.

In an example, the erosion techniques and segmentation techniques may be combined to select a plurality of pixels 302ₐ to 302ₚ of the pixels 302₁ to 302_{z}. As shown in FIG. 3, the plurality of pixels 302ₐ to 302ₚ may include segmentation to include pixels 302 around the center portion 308 and may also include erosion to remove pixels 302 around the outer edge or boundary of the center portion 308. The plurality of pixels 302ₐ to 302ₚ may be used to calculate the average transmission measurements for each object 212 in the image 210.

The number of pixels that is selected for erosion and segmentation may be a function of a desired application, mechanical property, image quality captured by the camera 104, a desired accuracy, and the like. In an example, to correlate UTS to the average transmission measurement with up to 90% accuracy, an erosion of 16 pixels and a segmentation of 5 pixels may be selected.

Although a “neck” of a dog bone shaped object 212 is used for segmentation in the examples provided above, it should be noted that the segmentation may be applied differently for differently shaped objects. For example, the object 212 may be analyzed with a physics simulation to determine a weak point. Then the pixels 302 associated with the weak point of the object 212 may be selected for segmentation.

The weak point may include a single location or multiple locations on the object 212. The weak point may include overlapping or non-overlapping locations on the object 212. When multiple weak points are identified on the object 212, each weak point may be segmented and analyzed to determine mechanical properties associated with those locations on the object 212.

As noted above, the average transmission measurement may be correlated to actual measured values of a mechanical property of the objects 110, illustrated in FIG. 1. These correlations may be used to establish a threshold for controlling operation of a 3D printer or machine that is used to produce the objects 110.

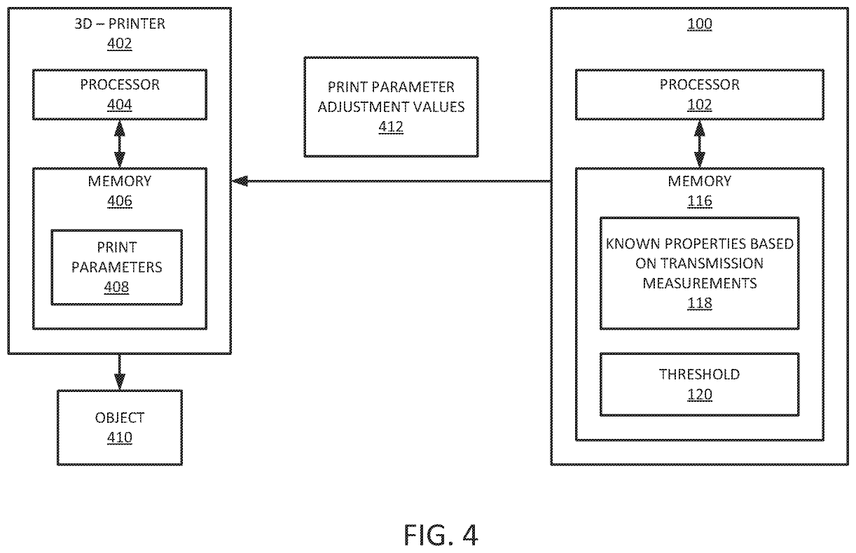

FIG. 4 illustrates a block diagram of the apparatus 100 and an example 3D printer 402 of the present disclosure. Although the example illustrated in FIG. 4 is related to a 3D printer, it should be noted that the apparatus 100 may also be used to change operational parameters of another machine that produces an object 410.

In an example, the 3D printer 402 may include a processor 404 and a memory 406. The memory 406 may include print parameters 408. The processor 404 may be communicatively coupled to the memory 406 and control operation of the 3D printer 402 in accordance with the print parameters 408 to print the object 410. The memory 406 may include any type of non-transitory computer readable medium, such as a hard disk drive, a random access memory, a solid state hard drive, and the like.

It should be noted that the 3D printer 402 has been simplified for ease of explanation and may include additional components that are not shown. For example, the 3D printer 402 may include a build material dispenser to dispense a build material, a platform to hold the build material, a printhead to dispense a binding fluid, a heat source to bind certain portions of the build material on the print bed, and the like. The 3D printer 402 may be a multi-jet fusion (MJF) printer, a selective laser sintering (SLS) printer, a fusion deposition modeling (FDM) printer, and the like.

In an example, the object 410 may be printed in accordance with the print parameters 408. The printer parameters 408 may include various print parameters such as a heating temperature, a heating time, an amount of binding fluid to be dispensed, an amount of build material per layer, and the like.

As noted above, the object 410 may be analyzed to determine whether the object 410 has a desired value for a mechanical property (e.g., UTS) using the apparatus 100. Based on analysis of the object 410, adjustments can be made to the print parameters 408 to improve the quality or mechanical properties of subsequently printed objects 410.

In an example, the apparatus 100 may include the processor 102 and further include a memory 116. The memory 116 may be any type of non-transitory computer readable medium, such as a hard disk drive, a random access memory, a solid state hard drive, and the like. The memory 116 may include known properties based on transmission measurements 118 and a threshold 120. The processor may be communicatively coupled to the memory 116 to execute instructions stored in the memory 116 or access information stored in the memory 116 to analyze the images 150 and to generate print parameter adjustment values 412.

In an example, the known properties based on transmission measurements may be stored in a table that has correlations of known mechanical property values for various transmission measurements. For example, as transmission measurements increase, the UTS values may increase or the elongation at break values may increase.

In an example, the threshold 120 may store acceptable threshold values of transmission measurements based on the known properties based on transmission measurements 118. In an example, the threshold 120 may vary for different types of 3D printers 402, different types of objects 410 (e.g., different shape, size, dimensions, and the like), different build materials used to print the objects 410, and the like.

In an example, the processor 102 may receive the print parameters 408 to print the object 410 from the 3D printer 402 or via a user interface (not shown). The images of the object 410 on the light table 106 may be captured and transmitted to the processor 102, as described above. The processor 102 may analyze the images to calculate an average transmission measurement for the object 410, as described above. The processor 102 may then compare the average transmission measurement to a threshold 120 stored in the memory 116. The threshold 120 may correspond to the 3D printer 402, the print parameters 408 used to print the object 410, and the like.

If the average transmission measurement exceeds the threshold 120, then the object 410 may have the desired mechanical properties, and the 3D printer 402 may continue to print additional copies of the object 410. Periodically, one of the objects 410 may be analyzed to ensure no defects are detected and/or that the 3D printer 402 is performing as desired.

If the average transmission measurement is below the threshold 120, then the object 410 may not have the desired mechanical properties. In an example, the processor 102 may generate the print parameter adjustment values 412 and transmit the print parameter adjustment values 412 to the 3D printer 402. The print parameters 408 may be modified in accordance with the print parameter adjustment values 412. A subsequent printed object 410 may be analyzed by the apparatus 100 and the process may be repeated until the average transmission measurement of the object 410 exceeds the threshold 120.

In an example, the print parameter adjustment values 412 may include changes to values of the print parameters 408. For example, parameters may include increasing a fusing temperature, decreasing a fusing temperature, changing a fusing time at a particular location, changing an amount of a fusing agent and/or binder applied at a particular location, and the like.

In another example, the print parameter adjustment values 412 may also include notification messages to be displayed on a display (not shown) of the 3D printer 402. For example, the analysis may show that a particular location on the object 410 has a defect. The location may correspond to a particular printhead or nozzle of the 3D printer. Thus, the notification may indicate that maintenance on the malfunctioning printhead/nozzle or replacement of the malfunctioning printhead/nozzle may be appropriate.

Thus, the present disclosure provides an apparatus 100 that can be used to efficiently analyze objects 110 for a mechanical property based on transmission measurements. The analysis can be performed in a non-destructive manner such that the objects 110 can be further analyzed for other properties. In addition, the analysis of the objects 110 for a desired mechanical property may be used to control or modify operations of a 3D printer or machine that produces the objects 410.

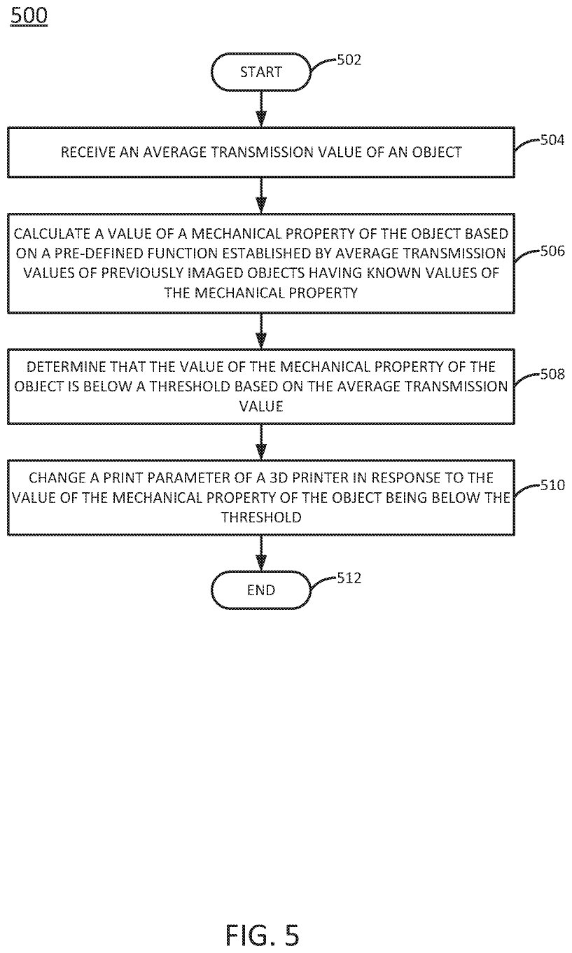

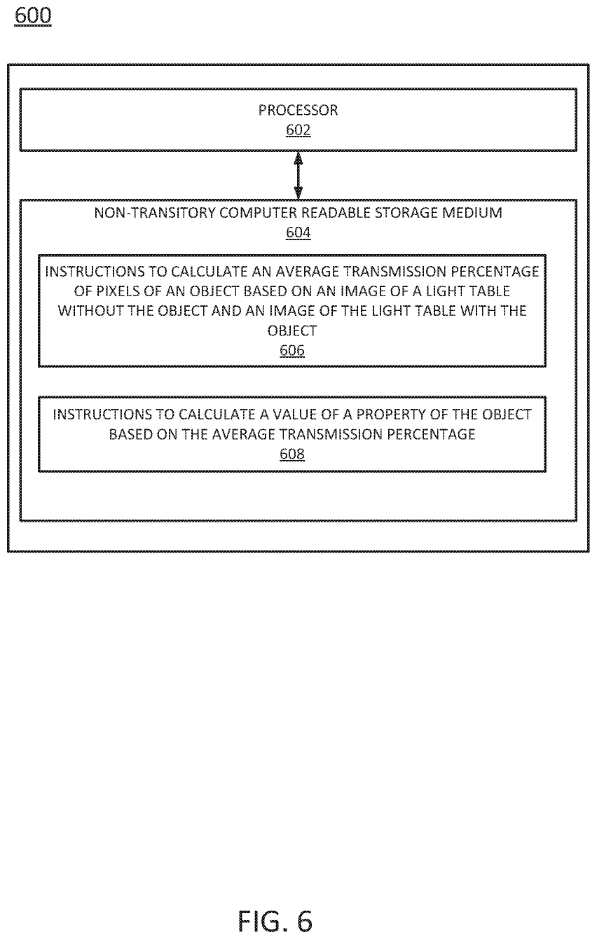

FIG. 5 illustrates a flow diagram of an example method 500 for measuring properties of an object based on transmission measurements of the present disclosure. In an example, the method 500 may be performed by the apparatus 100 or the apparatus 600 illustrated in FIG. 6, and described below.

At block 502, the method 500 begins. At block 504, the method 500 receives an average transmission value of an object. For example, an image of the object on a light table and an image of the light table without the object may be captured. The images may be converted from raw images to images with luminance values. The luminance values of pixels of the image of the object may be divided by luminance values of corresponding pixels in the image of the light table to calculate a per pixel transmission percentage or value. The average transmission value may be calculated by averaging the per pixel transmission values.

In an example, some of the pixels from the image of the object may be excluded. In an example, erosion and/or segmentation techniques may be applied to select a plurality of pixels that are a subset of all of the pixels of the object in the image. As noted above with reference to FIG. 3, erosion may exclude some pixels around the border of the object in the image. Segmentation may remove some pixels at the outer ends of the object in the image. The average transmission value may be calculated based on the per pixel transmission percentage of the selected plurality of pixels.

At block 506, the method 500 calculates a value of a mechanical property of the object based on a pre-defined function established by average transmission values of previously imaged objects having known values of the mechanical property. For example, test objects may be printed to measure and calculate transmission values of the test objects and then measure a value of a mechanical property of the object (e.g., UTS) using available destructive measurement methods. The value of the mechanical property can be correlated to the transmission values of the test objects using a pre-defined function (e.g., a function may be fitted through a representative set of data points). In an example, a quadratic function may be applied. However, it should be noted that any type of function (e.g., higher order polynomial function, spline, and so forth) may be used as long as it is suitable to fit the data. The correlation could also be established via a neural network. Calculated correlation coefficients can guide the selection of fitting functions as well as the number of points needed to determine a robust correlation. This correlation function may determine the accuracy of the prediction of the mechanical properties from the measured transmission values.

Subsequently printed objects may be analyzed to calculate a transmission value in block 504, as described above. The transmission value of the object may then be used in the pre-defined function to calculate the value of the mechanical property.

At block 508, the method 500 determines that the value of the mechanical property of the object is below a threshold based on the average transmission value. In one example, a threshold may be established based on a desired value of the mechanical property for the object. The value of the mechanical property may be calculated based on the pre-defined function using the transmission value of the object.

If the value of the mechanical property is above the threshold, the machine that produces the object may continue to produce the object using current print parameters. However, if the value of the mechanical property is below the threshold, the method 500 may continue to block 510.

At block 510, the method 500 changes a print parameter of a 3D printer in response to the value of the mechanical property of the object being below the threshold. For example, certain print parameters may affect the value of the mechanical property. For example, the print parameters may include fusing temperature, fusing time, amounts of binding material at a particular location, and the like. In an example, changes or modifications to the print parameter may include decreasing a fusing temperature, changing a fusing time at a particular location, changing an amount of binder applied at a particular location, and the like.

In other examples, the changes may include changes or modifications to physical components. For example, the value of the mechanical property may fall due to a malfunctioning or failing printhead and/or nozzle. Thus, the changes to the print parameter may include performing maintenance or replacing the malfunctioning printhead and/or nozzle. At block 512, the method 500 ends.

FIG. 6 illustrates an example of an apparatus 600. In an example, the apparatus 600 may be the apparatus 100. In an example, the apparatus 600 may include a processor 602 and a non-transitory computer readable storage medium 604. The non-transitory computer readable storage medium 604 may include instructions 606 and 608 that, when executed by the processor 602, cause the processor 602 to perform various functions.

In an example, the instructions 606 may include instructions to calculate an average transmission percentage of pixels of an object based on an image of a light table without the object and an image of the light table with the object. The instructions 608 may include instructions to calculate a value of a property of the object based on the average transmission percentage.

It will be appreciated that variants of the above-disclosed and other features and functions, or alternatives thereof, may be combined into many other different systems or applications. Various presently unforeseen or unanticipated alternatives, modifications, or variations therein may be subsequently made by those skilled in the art which are also intended to be encompassed by the following claims.

1. An apparatus, comprising:
a light table to emit a light through an object on the light table;
a camera to capture an image of the light table; and
a processor communicatively coupled to the light table and the camera, the processor to:
receive an image of the light table without the object;
receive an image of the light table with the object; and
calculate transmission values for a plurality of pixels of the object in the image of the light table with the object, wherein a mechanical property of the object is to be determined based on the transmission values.

2. The apparatus of claim 1, wherein the object is translucent.

3. The apparatus of claim 1, wherein a plurality of objects is located on the light table and the processor is to receive an image of the light table with the plurality of objects and to calculate the transmission values for respective pluralities of pixels of each one of the plurality of objects in an image of the light table with the plurality of objects.

4. The apparatus of claim 1, wherein a transmission value of the transmission values comprises a percentage of the light that passes through the object at a pixel location.

5. The apparatus of claim 1, wherein the processor is further to:
calculate an average transmission value for the plurality of pixels of the object; and
correlate the average transmission value to a mechanical property value.

6. The apparatus of claim 5, further comprising:
a memory communicatively coupled to the processor, wherein the memory is to store the average transmission value that is correlated to a desired value of the mechanical property of the object, wherein the average transmission value is to be compared to average transmission values of subsequently imaged objects to determine if the subsequently imaged objects have the desired value of the mechanical property.

7. A method, comprising:
receiving, by a processor, an average transmission value of an object;
calculating, by the processor, a value of a mechanical property of the object based on a pre-defined function established based on average transmission values of previously imaged objects having known values of the mechanical property;
determining, by the processor, that the value of the mechanical property of the object is below a threshold based on the average transmission value; and
changing, by the processor, a print parameter of a 3D printer in response to the value of the mechanical property of the object being below the threshold.

8. The method of claim 7, wherein the average transmission value of the object comprises a transmission percentage that is calculated by, for each pixel, dividing values of pixels of an image of the object on a light table by values of pixels of an image of the light table without the object at a same location.

9. The method of claim 8, wherein border pixels are removed before the transmission percentage of the object is calculated.

10. The method of claim 8, wherein the image of the object is segmented before the transmission percentage of the object is calculated.

11. The method of claim 7, wherein the print parameter of the 3D printer that is changed comprises at least one of: modifying a fusing temperature, changing an amount of fusing agent or binder to be applied at a particular location, replacing a malfunctioning print nozzle, or changing a fusing time for a particular location.

12. A non-transitory computer readable storage medium encoded with instructions executable by a processor, the non-transitory computer-readable storage medium comprising:
instructions to calculate an average transmission percentage of pixels of an object based on an image of a light table without the object and an image of the light table with the object; and
instructions to calculate a value of a property of the object based on the average transmission percentage.

13. The non-transitory computer readable storage medium of claim 12, wherein the pixels of the object exclude boundary pixels.

14. The non-transitory computer readable storage medium of claim 13, wherein the pixels of the object are part of a segment of the image of the object.

15. The non-transitory computer readable storage medium of claim 12, further comprising:
instructions to compare the value of the property to a threshold; and
instructions to change a parameter of a 3D printer when the value of the property is below the threshold.
